(19) United States
(12) Patent Application Publication
(10) Pub. No.: US 2016/0182919 A1
(43) Pub. Date: Jun. 23, 2016

(54) TRANSMITTING DEVICE AND RECEIVING DEVICE

(71) Applicant: Kabushiki Kaisha Toshiba, Tokyo (JP)

(72) Inventor: Tomohiro KANDA, Saitama Saitama (JP)

(21) Appl. No.: 14/818,865

(22) Filed: Aug. 5, 2015

Related U.S. Application Data
(60) Provisional application No. 62/095,330, filed on Dec. 22, 2014.

(51) Int. Cl. H04N 19/89; H04L 29/06

(52) U.S. Cl. CPC H04N 19/89; H04L 65/4069

(57) ABSTRACT

According to an embodiment, a transmitting device includes, for example, a display, an encoder, and a controller. The display is configured to display a dynamic image. The encoder is configured to encode a dynamic image displayed on the display and generate a dynamic image stream, the dynamic image stream including an IDR frame and a P frame subsequent to the IDR frame and having a bit rate within a first bit rate range. The controller is configured to, when receiving first information instructing transmission of an IDR frame from an external device during the time of transmitting a P frame to the external device, lower the upper limit of the first bit rate range, cause the encoder to generate the IDR frame, transmit the generated IDR frame to the external device via wireless communication, and restart transmitting the P frame generated subsequent to the IDR frame.

### CROSS-REFERENCE TO RELATED APPLICATIONS

This application claims the benefit of U.S. Provisional Patent Application No. 62/095,330, filed on Dec. 22, 2014, the entire contents of which are incorporated herein by reference.

### FIELD

The embodiments described herein relate generally to a transmitting device and a receiving device.

### BACKGROUND

Miracast (registered trademark) has been developed by Wi-Fi Alliance (registered trademark) and mounted on products as a standard for transferring dynamic images such as screen information displayed on a source terminal from the source terminal to a sink terminal via wireless communication. Miracast implements transfer of screen information between terminals by encoding screen information at a source terminal and transmitting the information to a sink terminal by use of direct communication (Wi-Fi Direct (registered trademark)) between terminals via wireless communication.

With Miracast, when a packet loss of screen information occurs on the way of transferring the screen information between terminals due to congestion of wireless communication and the like, a video recovery function enables the sink terminal to restart decoding the screen information. However, such a packet loss is likely to occur again and the video recovery function is thus repeatedly performed. Repetition of the video recovery function causes repeated stop of decoding the screen information displayed on the sink terminal, which deteriorates the image quality of the screen information. The video recovery function is a function for transmitting, to the source terminal, an instantaneous decoder refresh (IDR) instructing transmission of an IDR frame, which makes it possible to decode a frame to be displayed as screen information without using a frame prior to the frame to be displayed, when an error in decoding screen information is detected at the sink terminal.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a drawing that illustrates an example of the configuration of a communication system according to a first embodiment;

FIG. 2 is a drawing that illustrates an example of the hardware configuration of a source terminal of the communication system according to the first embodiment;

FIG. 3 is a drawing that illustrates an example of the hardware configuration of a sink terminal of the communication system according to the first embodiment;

FIG. 4 is a sequence drawing that illustrates an example of a flow of common image transferring processing performed between a source terminal and a sink terminal;

FIG. 5 is a sequence drawing that illustrates an example of a flow of image transferring processing performed between the source terminal and the sink terminal of the communication system according to the first embodiment;

FIG. 6 is a sequence drawing that illustrates an example of a flow of image transferring processing performed between a source terminal and a sink terminal of a communication system according to a second embodiment;

FIG. 7 is a drawing that illustrates an example of a highest bit rate transmission request transmitted from the sink terminal of the communication system according to the second embodiment;

FIG. 8 is a drawing that illustrates an example of a third response transmitted from the source terminal of the communication system according to the second embodiment;

FIG. 9 is a drawing that illustrates an example of an instantaneous decoder refresh (IDR) request transmitted from the sink terminal of the communication system according to the second embodiment;

FIG. 10 is a sequence drawing that illustrates an example of a flow of image transferring processing performed between a source terminal and a sink terminal of a communication system according to a third embodiment; and

FIG. 11 is an example of a bit rate input screen displayed on the sink terminal of the communication system according to the third embodiment.

### DETAILED DESCRIPTION

According to an embodiment, a transmitting device generally comprises a display, an encoder, and a controller. The display is configured to display a dynamic image. The encoder is configured to encode the dynamic image displayed on the display and generate a dynamic image stream, the dynamic image stream including an IDR frame and a P frame subsequent to the IDR frame and having a bit rate within a first bit rate range. The controller is configured to, when receiving first information instructing transmission of an IDR frame from an external device during the time of transmitting a P frame to the external device, lower the upper limit of the first bit rate range, cause the encoder to generate the IDR frame, transmit the generated IDR frame to the external device via wireless communication, and restart transmitting the P frame generated subsequent to the IDR frame.

A transmitting device and a receiving device according to the present embodiment will now be described with reference to the accompanying drawings.

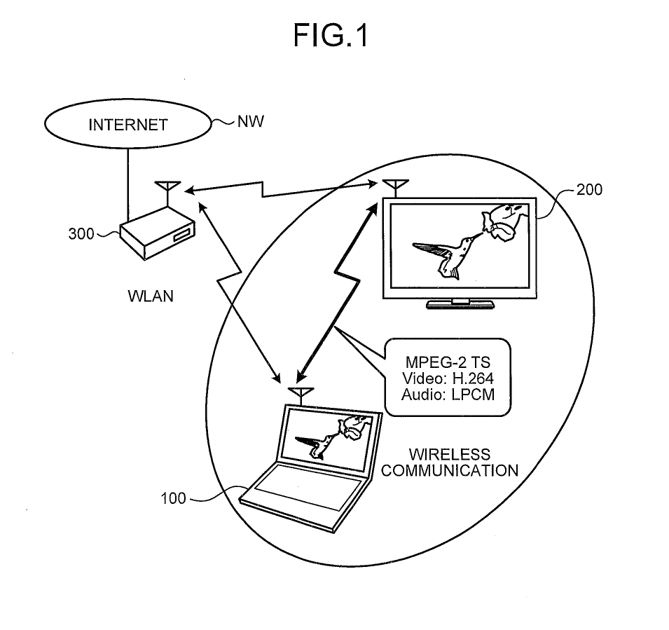

FIG. 1 is a drawing that illustrates an example of the configuration of a communication system according to a first embodiment. As FIG. 1 illustrates, the communication system according to the present embodiment includes a source terminal 100, a sink terminal 200, and an access point 300.

The source terminal 100 is an example of a transmitting device configured by a smart phone, a tablet terminal, a notebook computer, and the like. The source terminal 100 is capable of accessing a network NW such as the Internet via the access point 300. The source terminal 100 is capable of having wireless communication with the sink terminal 200 via the access point 300 by a wireless local area network (WLAN). Furthermore, the source terminal 100 is capable of having wireless communication with the sink terminal 200 by a wireless personal area network (WPAN) such as Wi-Fi.

The sink terminal 200 is an example of a receiving device configured by a digital television and the like. The sink terminal 200 is capable of accessing the network NW via the access point 300. The sink terminal 200 is capable of having wireless communication with the source terminal 100 via the access point 300 by the WLAN. Furthermore, the sink terminal 200 is capable of having wireless communication with the source terminal 100 by Wi-Fi and the like.

In the present embodiment, the source terminal 100 encodes a dynamic image (a moving image, such as screen information displayed on a display of the source terminal 100) displayed on the source terminal 100 in accordance with a standard for compressing a dynamic image such as H.264 and encodes a voice replayed on the source terminal 100 in accordance with a standard for encoding a voice such as a linear pulse code modulation (LPCM). The source terminal 100 multiplexes the encoded dynamic image and voice with a format such as MPEG-2TS and transmits the multiplex data generated by multiplexing the dynamic image and voice to the sink terminal 200 via wireless communication. The sink terminal 200 receives the dynamic image transmitted from the source terminal 100. The sink terminal 200 then decodes the received dynamic image and displays the image on a display of the sink terminal 200. In this way, the communication system of the present embodiment performs image transferring processing for displaying a dynamic image displayed on a display of the source terminal 100 on a display of the sink terminal 200.

Examples of the access point 300 are configured by a wireless router. The access point 300 has wireless communication with the source terminal 100 and the sink terminal 200 by the WLAN, thereby relaying communication between the source terminal 100 and the sink terminal 200 and connecting the source terminal 100 and the sink terminal 200 to the network NW.

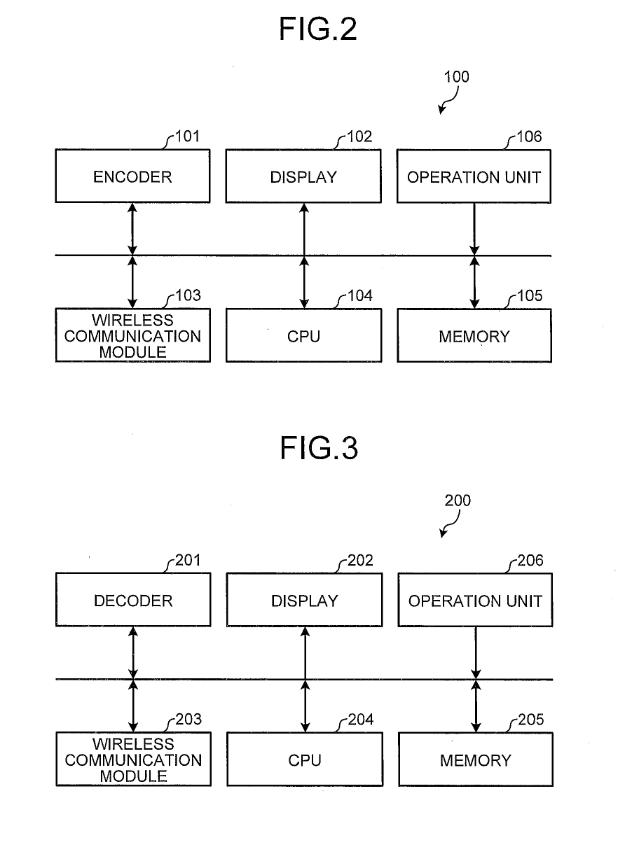

FIG. 2 is a drawing that illustrates an example of the hardware configuration of the source terminal of the communication system according to the first embodiment. As FIG. 2 illustrates, the source terminal 100 includes an encoder 101, a display 102, a wireless communication module 103, a central processing unit (CPU) 104, a memory 105, and an operation unit 106. In the present embodiment, the encoder 101, the wireless communication module 103, the CPU 104, and the memory 105 are mounted on an electronic circuit.

Examples of the display 102 are configured by a liquid crystal display (LCD), and the display 102 is capable of displaying various kinds of information. Examples of the operation unit 106 are configured by such as a touch panel provided on the display 102 and capable of detecting a touch operation made by a user and a keyboard. A user of the source terminal 100 can input various kinds of information with the operation unit 106. The wireless communication module 103 is a communication module that has wireless communication with an external device such as the sink terminal 200 and the access point 300. The encoder 101 encodes various kinds of information (such as information of a dynamic image and a voice transmitted to the sink terminal 200 via wireless communication) transmitted to the sink terminal 200 and the access point 300 by the wireless communication module 103. Examples of the memory 105 are configured by a read only memory (ROM) and a random access memory (RAM), and the memory 105 stores therein various programs executed by the CPU 104 and various kinds of information. The CPU 104 is a controller that executes various programs stored in the memory 105 and thereby totally controlling the source terminal 100. In the present embodiment, the encoder 101 is implemented with hardware; however, any configurations are applicable without being limited to this configuration. The encoder 101 may be implemented with software executed by the CPU 104. The functions of the controller-implemented by the CPU 104 as software may be implemented with hardware.

FIG. 3 is a drawing that illustrates an example of the hardware configuration of the sink terminal of the communication system according to the first embodiment. As FIG. 3 illustrates, the sink terminal 200 includes a decoder 201, a display 202, a wireless communication module 203, a CPU 204, a memory 205, and an operation unit 206. In the present embodiment, the decoder 201, the wireless communication module 203, the CPU 204, and the memory 205 are mounted on an electronic circuit.

Examples of the display 202 are configured by a liquid crystal display (LCD), and the display 202 is capable of displaying various kinds of information such as a dynamic image received from the source terminal 100. Examples of the operation unit 206 are configured by such as various kinds of buttons. A user of the sink terminal 200 can input various kinds of information with the operation unit 206. The wireless communication module 203 is a communication module that is configured to have wireless communication with an external device such as the source terminal 100 and an access point. The decoder 201 decodes various kinds of information received from the source terminal 100 and the access point 300 by the wireless communication module 203. Examples of the memory 205 are configured by a read only memory (ROM) and a random access memory (RAM), and the memory 205 stores therein various programs executed by the CPU 204 and various kinds of information. The CPU 204 is a controller that executes various programs stored in the memory 205 and thereby totally controlling the sink terminal 200. In the present embodiment, the decoder 201 is implemented with hardware; however, any configurations are applicable without being limited to this configuration. The decoder 201 may be implemented with software executed by the CPU 204. The functions of the controller implemented by the CPU 204 as software may be implemented with hardware.

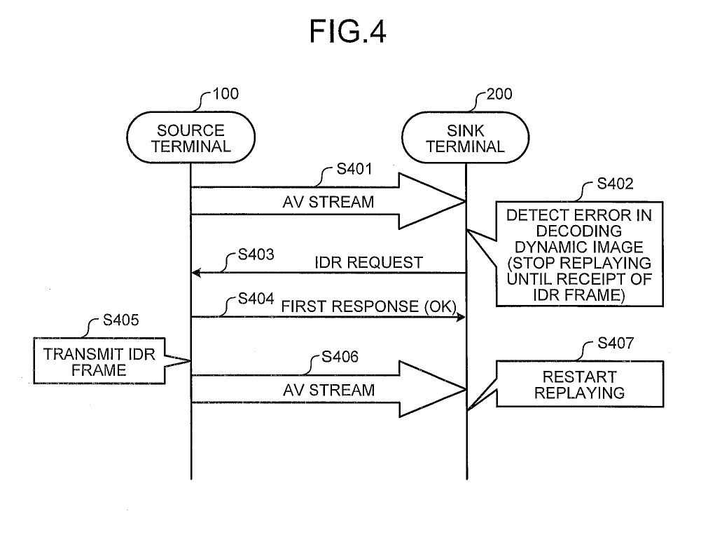

A flow of common image transferring processing performed between the source terminal 100 and the sink terminal 200 will now be described with reference to FIG. 4. FIG. 4 is a sequence drawing that illustrates an example of a flow of common image transferring processing performed between a source terminal and a sink terminal. When the CPU 104 of the source terminal 100 receives an instruction to execute image transferring processing through the operation unit 106, the CPU 104 of the source terminal 100 detects sink terminals 200 that can make wireless communication with the source terminal 100 via the wireless communication module 103. The CPU 104 selects a sink terminal 200 designated by a user through the operation unit 106 out of the detected sink terminals 200 as a destination for transferring a dynamic image by performing the image transferring processing. The CPU 104 establishes communication with the sink terminal 200 selected as a destination via the wireless communication module 103 and thereby arranging conditions for wireless communication with the sink terminal 200.

When wireless communication with the sink terminal 200 becomes available, the CPU 104 of the source terminal 100 performs screen control communication with the sink terminal 200 via the wireless communication module 103 to transmit and receive control information used for the screen transferring processing using the transmission control protocol/Internet protocol (TCP/IP), the real time streaming protocol (RTSP), or the like. In specific, the CPU 104 determines the data format (such as the resolution and the frame rate of a dynamic image) of a dynamic image transmitted from the source terminal 100 to the sink terminal 200 through the screen control communication. The CPU 104 thereafter transmits the determined data format to the sink terminal 200 via the wireless communication module 103.

After the screen control communication with the sink terminal 200, the CPU 104 of the source terminal 100 executes the screen transferring processing for transmitting a stream (a dynamic image stream) of a dynamic image displayed on the display 102 to the sink terminal 200 via the wireless communication module 103 by wireless communication at a bit rate within a predetermined bit rate range. In the present embodiment, the CPU 104 transmits a dynamic image stream including a dynamic image displayed on the display 102 to the sink terminal 200 using the user datagram protocol/the Internet protocol (UDP/IP) or the real-time transport protocol (RTP). Furthermore, in the present embodiment, the CPU 104 transmits, to the sink terminal 200, a stream (an audio video (AV) stream) generated by multiplexing sound information such as a voice on the dynamic image stream including the dynamic image displayed on the display 102 (S401).

For reducing the amount of information included in the dynamic image stream transmitted to the sink terminal 200, the encoder 101 of the source terminal 100 encodes the dynamic image displayed on the display 102 in accordance with a standard such as H.264 for compressing a dynamic image and thereby generating a dynamic image stream. The CPU 104 thereafter transmits the dynamic image stream generated by the encoder 101 to the sink terminal 200. In specific, the encoder 101 generates a frame (a P frame) by encoding a frame of the dynamic image displayed on the display 102 by use of another frame (an I frame, an IDR frame, which will be described later, or a P frame) having been encoded prior to the frame as a reference picture. The encoder 101 encodes the dynamic image stream including an IDR frame and the generated frame (the P frame) in a manner of having a bit rate within a predetermined bit rate range. And the CPU104 transmits the encoded dynamic image stream to the sink terminal 200 via the wireless communication module 103. The encoder 101 generates, in every predetermined time (for example, every ten seconds), a frame (an instantaneous decoder refresh (IDR) frame) that can be decoded by a decoder without using another frame prior to the frame to be decoded. In other words, the IDR frame is a frame that can be independently decoded without referring to other frames. Only frames coming after the IDR frame are associated with the P frames subsequent to the IDR frame as reference pictures. The encoder 101 encodes the dynamic image stream including the generated frame (the IDR frame) in a manner of having a bit rate within a predetermined bit rate range. The CPU 104 transmits the encoded dynamic image stream to the sink terminal 200 via the wireless communication module 103. The predetermined bit rate range is a bit rate range allowed in transmitting a frame to the sink terminal 200. In the present embodiment, a bit rate range equal to or less than the highest bit rate (for example, 10 Mbps) preset for the encoder 101 is set as a predetermined bit rate range. The CPU 104 transmits a frame to the sink terminal 200 in accordance with UDP/IP and thereby retransmitting no frames even if a packet loss occurs on the way of transferring the dynamic image from the source terminal 100 to the sink terminal 200.

When communication between the source terminal 100 and the sink terminal 200 has been established via the wireless communication module 203 and wireless communication becomes available between the source terminal 100 and the sink terminal 200, the CPU 204 of the sink terminal 200 receives the dynamic image stream transmitted from the source terminal 100 (S401). The decoder 201 generates a frame by decoding the P frame in the received dynamic image stream by use of a frame (an I frame, an IDR frame, or a P frame) prior to the P frame. The CPU 204 thereafter displays the frame generated by the decoder 201 on the display 202.

The CPU 204 of the sink terminal 200 detects an error (such as an error that fails to continue decoding the P frame of the received dynamic image stream and an error that has many noises on the dynamic image displayed on the display 202) in decoding the P frame in the received dynamic image stream, the error which occurs due to a packet loss or the like on the way of transferring the dynamic image from the source terminal 100 to the sink terminal 200, while the decoder 201 is decoding the P frame in the received dynamic image stream (S402). When the CPU 204 detects an error in decoding the frame of the received dynamic image, the CPU 204 stops the decoder 201 decoding (replaying) the frame until the CPU 204 receives an IDR frame (S402). The CPU 204 further transmits an IDR request that instructs transmission of an IDR frame, to the source terminal 100 via the wireless communication module 203 in accordance with TCP/IP, RTSP, or the like (S403).

When the CPU 104 of the source terminal 100 receives the IDR request from the sink terminal 200 via the wireless communication module 103 during the time of transmitting a dynamic image stream including a P frame to the sink terminal 200, the CPU 104 of the source terminal 100 transmits a first response to the sink terminal 200 to notify of receipt of the IDR request and of the value of the highest bit rate (the highest bit rate value), which is the upper limit of the predetermined bit rate range, in accordance with TCP/IP, RTSP, or the like (S404).

The encoder 101 of the source terminal 100 generates an IDR frame in response to the receipt of the IDR request. More specifically, the encoder 101 generates an IDR frame at the timing of receipt of an IDR request even when the encoder 101 is generating a P frame in regular encoding processing. For example, provided that the encoder 101 generates an IDR frame in every ten seconds and generates a P frame in the interval of generating the IDR frame, when an IDR request is received during the time of generating a P frame, the encoder 101 stops generating the P frame and generates an IDR frame. The CPU 104 of the source terminal 100 transmits the IDR frame generated by the encoder 101 to the sink terminal 200 via the wireless communication module 103 (S405) and restarts transmitting a frame (a P frame) generated by the encoder 101 subsequent to the IDR frame to the sink terminal 200. With this process, the CPU 104 restarts transmitting an AV stream to the sink terminal 200 (S406).

When the CPU 204 of the sink terminal 200 receives the IDR frame from the source terminal 100 via the wireless communication module 203, the CPU 204 of the sink terminal 200 causes the decoder 201 to restart decoding (replaying) a frame (S407).

In the image transferring processing illustrated with S401 to S407, a packet loss frequently occurring due to congestion of wireless communication on the way of transferring a dynamic image from the source terminal 100 to the sink terminal 200 causes repeated transmission of an IDR request from the sink terminal 200 to the source terminal 100. Consequently, the decoder 201 of the sink terminal 200 repeatedly stops decoding, which markedly damages the quality of the dynamic image displayed on the sink terminal 200.

In the present embodiment, when the source terminal 100 receives an IDR request from the sink terminal 200, the source terminal 100 lowers the highest bit rate used in transmitting a frame to the sink terminal 200. This process decreases the frequency at which a packet loss occurs on the way of transferring a dynamic image from the source terminal 100 to the sink terminal 200, thereby reducing deterioration of the quality of the dynamic image displayed on the sink terminal 200.

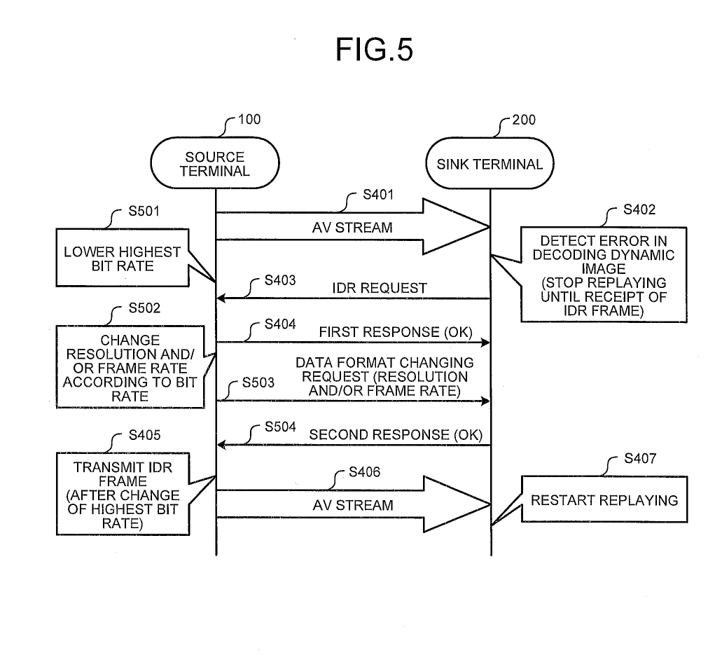

The image transferring processing performed between the source terminal 100 and the sink terminal 200 of the communication system according to the present embodiment will now be described with reference to FIG. 5. FIG. 5 is a sequence drawing that illustrates an example of a flow of the image transferring processing performed between a source terminal and a sink terminal of the communication system according to the first embodiment. Description about the same processing as the common image transferring processing performed between the source terminal 100 and the sink terminal 200 as FIG. 4 illustrates will be omitted in the following description.

When the CPU 104 of the source terminal 100 receives an IDR request from the sink terminal 200 via the wireless communication module 103, the CPU 104 of the source terminal 100 lowers the highest bit rate which is the upper limit of a predetermined bit rate range (S501). This process can decrease the frequency at which a packet loss occurs on the way of transferring a dynamic image from the source terminal 100 to the sink terminal 200, which prevents the sink terminal 200 from repeatedly stopping decoding a frame and accordingly prevents deterioration of the image quality of the dynamic image displayed on the sink terminal 200.

In the present embodiment, the CPU 104 of the source terminal 100 lowers the highest bit rate every time the CPU 104 receives an IDR request from the sink terminal 200; however, any configurations are applicable without being limited to this configuration as long as the highest bit rate is lowered in response to receipt of an IDR request from the sink terminal 200. For example, the CPU 104 may lower the highest bit rate when the CPU 104 receives IDR requests a plurality of times within a predetermined time unit (such as ten seconds).

In the present embodiment, when the CPU 104 of the source terminal 100 lowers the highest bit rate upon receipt of an IDR request from the sink terminal 200, the CPU 104 of the source terminal 100 keeps the highest bit rate lowered regardless of the quality of the wireless communication between the source terminal 100 and the sink terminal 200. The CPU 104 of the source terminal 100 may return the highest bit rate to the initial highest bit rate upon improvement in the quality of the wireless communication between the source terminal 100 and the sink terminal 200 or upon receipt of information input instructing raising of the highest bit rate from an external device such as the sink terminal 200.

The CPU 104 of the source terminal 100 transmits the first response notifying of receipt of the IDR request to the sink terminal 200 and changes the data format (such as the resolution and the frame rate) of a frame transmitted to the sink terminal 200 based on the predetermined bit rate range with its highest bit rate changed (S502). If the CPU 104 determines that, with the lowered highest bit rate, the current data format of the frame causes deterioration of the image quality of the dynamic image displayed on the sink terminal 200, the CPU 104 lowers at least one of the resolution and the frame rate of the frame transmitted to the sink terminal 200. When the CPU 104 changes the data format of the frame transmitted to the sink terminal 200, the CPU 104 transmits a data format changing request notifying of the changed data format (such as the resolution and the frame rate) to the sink terminal 200 via the wireless communication module 103 in accordance with TCP/IP, RTSP, or the like (S503). In the present embodiment, the CPU 104 changes the data format of a frame transmitted to the sink terminal 200 upon a change in the highest bit rate; however, the CPU 104 may transmit the frame to the sink terminal 200 without changing the data format of the frame transmitted to the sink terminal 200.

When the CPU 204 of the sink terminal 200 receives the data format changing request from the source terminal 100 via the wireless communication module 203, the CPU 204 of the sink terminal 200 transmits a second response notifying of receipt of the data format changing request, to the source terminal 100 in accordance with TCP/IP, RTSP, or the like (S504).

When the CPU 104 of the source terminal 100 receives the second response from the sink terminal 200, the CPU 104 of the source terminal 100 transmits an IDR frame generated by the encoder 101 to the sink terminal 200 at a bit rate within the predetermined bit rate range with its highest bit rate lowered (S405). The CPU 104 thereafter restarts transmitting a frame (a P frame) generated by the encoder 101 to the sink terminal 200 at a bit rate within the predetermined bit rate range with its highest bit rate lowered.

The communication system according to the first embodiment can prevent the sink terminal 200 from repeatedly stopping decoding a frame and accordingly prevent deterioration of the image quality of a dynamic image displayed on the sink terminal 200.

A communication system according to a second embodiment will now be described. In the present embodiment, the source terminal 100 receives an IDR request indicating a bit rate lower than the upper limit (the highest bit rate) of a predetermined bit rate range and changes the highest bit rate within the predetermined bit rate range to the bit rate indicated by the received IDR request. Overlapping description with the first embodiment will be omitted in the following description.

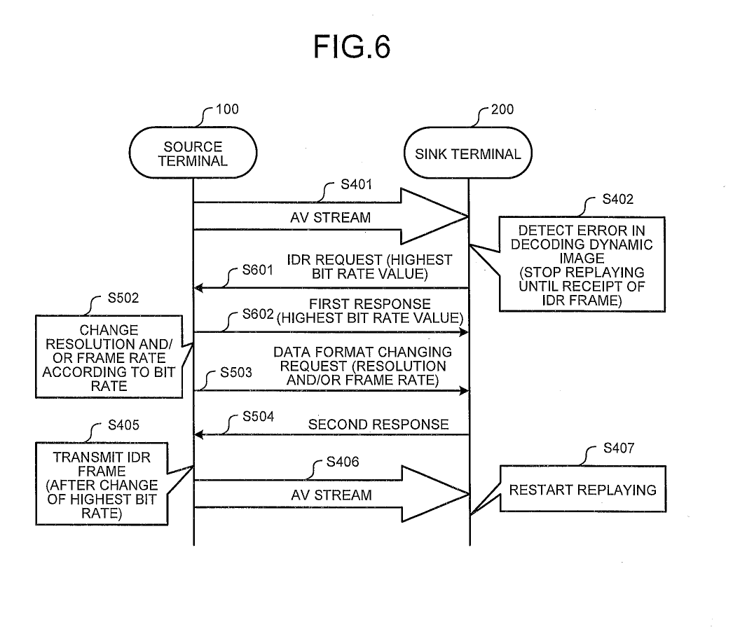

FIG. 6 is a sequence drawing that illustrates an example of a flow of image transferring processing performed between a source terminal and a sink terminal of the communication system according to the second embodiment. Description about the same processing as the image transferring processing performed between the source terminal 100 and the sink terminal 200 as FIG. 5 illustrates will be omitted in the following description.

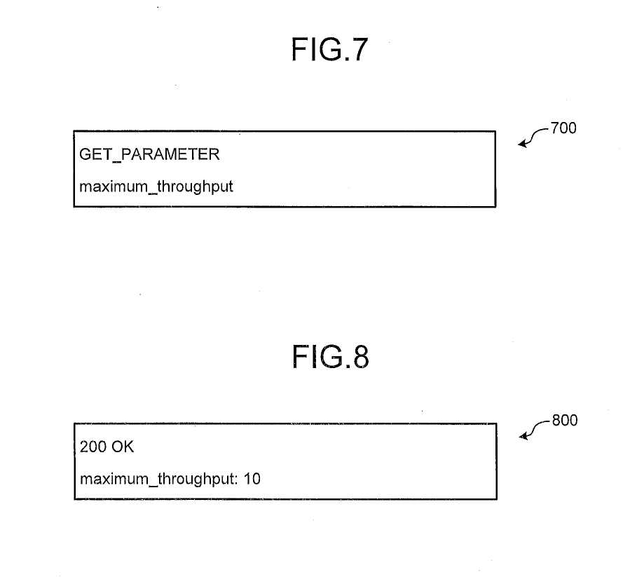

The CPU 204 of the sink terminal 200 transmits a highest bit rate value transmission request, which instructs transmission of the highest bit rate value, to the source terminal 100 via the wireless communication module 203 in accordance with TCP/IP, RTSP, or the like before starting receiving a dynamic image stream from the source terminal 100 or after starting receiving a dynamic image stream from the source terminal 100. FIG. 7 is a drawing that illustrates an example of the highest bit rate value transmission request transmitted from the sink terminal of the communication system according to the second embodiment. As FIG. 7 illustrates, the CPU 204 transmits a highest bit rate value transmission request 700, which includes a command for instructing transmission of the highest bit rate value, to the source terminal 100 in accordance with TCP/IP, RTSP, or the like.

When the CPU 104 of the source terminal 100 receives the highest bit rate value transmission request from the sink terminal 200 via the wireless communication module 103, the CPU 104 of the source terminal 100 transmits a third response notifying of the highest bit rate value, to the sink terminal 200 in accordance with TCP/IP, RTSP, or the like. FIG. 8 is a drawing that illustrates an example of the third response transmitted from the source terminal of the communication system according to the second embodiment. As FIG. 8 illustrates, the CPU 104 transmits, to the sink terminal 200, a third response 800 indicating the highest bit rate value (for example, 10 Mbps) in a predetermined bit rate range currently set.

If the CPU 204 of the sink terminal 200 detects an error in decoding a frame of a dynamic image transmitted from the source terminal 100 (S402), the CPU 204 of the sink terminal 200 transmits an IDR request, which indicates a highest bit rate value lower than the current highest bit rate value indicated by the third response transmitted from the source terminal 100, to the source terminal 100 via the wireless communication module 203 (S601). The CPU 204 may transmit the IDR request indicating a highest bit rate value lower than the current highest bit rate value to the source terminal 100 every time the CPU 204 transmits the IDR request to the source terminal 100. Alternatively, the CPU 204 may transmit the IDR request indicating a highest bit rate value lower than the current highest bit rate value to the source terminal 100 when errors in decoding a frame of a dynamic image transmitted from the source terminal 100 are detected a plurality of times within a predetermined time unit.

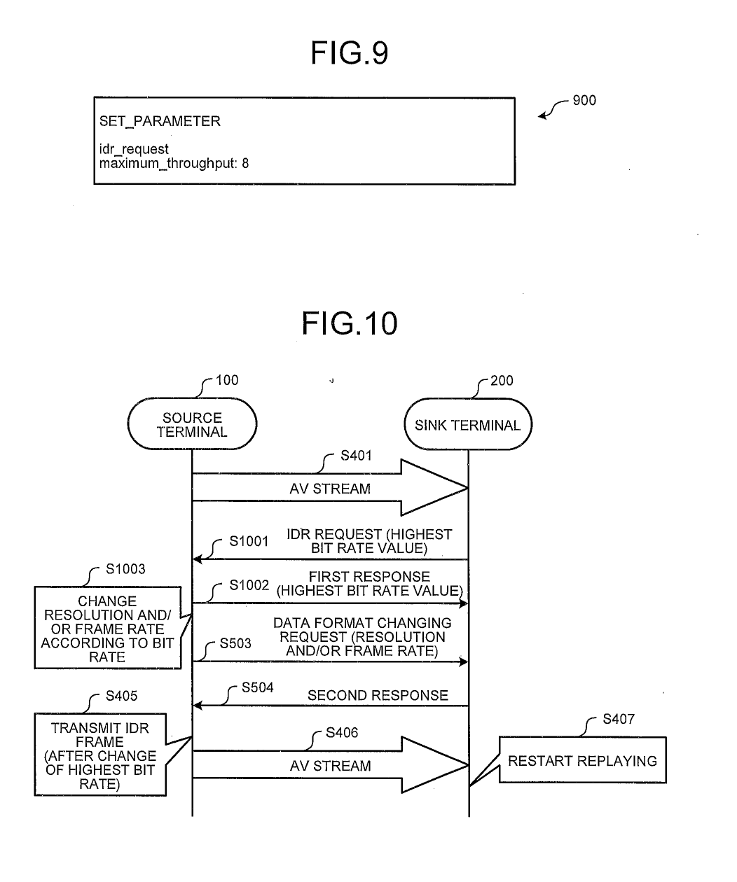

FIG. 9 is a drawing that illustrates an example of an IDR request transmitted from the sink terminal of the communication system according to the second embodiment. As FIG. 9 illustrates, the CPU 204 transmits, to the source terminal 100, an IDR request 900 that indicates a change in the highest bit rate value from the current value (for example, 10 Mbps) indicated by the third response transmitted from the source terminal 100 to a value (for example, 8 Mbps) lower than the current value.

When the CPU 104 of the source terminal 100 receives the IDR request from the sink terminal 200, the CPU 104 of the source terminal 100 lowers the highest bit rate in the predetermined bit rate range according to the highest bit rate value indicated by the received IDR request. This process can decrease the frequency at which a packet loss occurs on the way of transferring a dynamic image from the source terminal 100 to the sink terminal 200, which prevents the sink terminal 200 from repeatedly stopping decoding a frame and accordingly prevents deterioration of the image quality of a dynamic image displayed on the sink terminal 200. The CPU 104 thereafter transmits the first response notifying of the changed highest bit rate value to the sink terminal 200 via the wireless communication module 103 (S602).

In this way, the communication system according to the second embodiment exerts the same advantageous effects as those of the first embodiment.

A communication system according to a third embodiment will now be described. In the present embodiment, upon receipt of an IDR request indicating a bit rate value input to a sink terminal, the highest bit rate in a predetermined bit rate range is changed according to the bit rate value indicated by the IDR request. Overlapping description with the first embodiment will be omitted in the following description.

FIG. 10 is a sequence drawing that illustrates an example of a flow of image transferring processing performed between a source terminal and a sink terminal of the communication system according to the third embodiment. Description about the same processing as the image transferring processing performed between the source terminal 100 and the sink terminal 200 as FIG. 5 illustrates will be omitted in the following description.

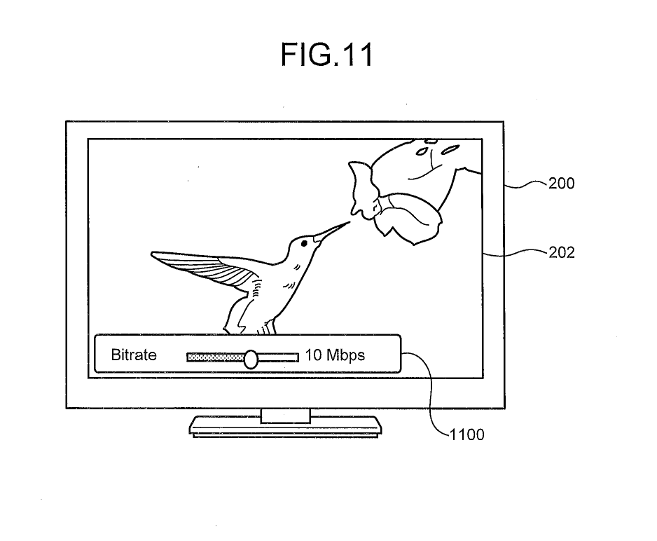

When the highest bit rate is changed through the operation unit 206, the CPU 204 of the sink terminal 200 transmits an IDR request indicating the highest bit rate value input through the operation unit 206 to the source terminal 100 via the wireless communication module 203 (S1001). FIG. 11 is an example of a bit rate input screen displayed on the sink terminal of the communication system according to the third embodiment. As FIG. 11 illustrates, when an instruction for displaying a user interface used to change the highest bit rate is input through the operation unit 206, the CPU 204 displays a graphic user interface (GUI) 1100 used to input the highest bit rate value on the display 202. When the highest bit rate value is input by operating the GUI 1100 with the operation unit 206, the CPU 204 transmits an IDR request indicating the input highest bit rate value to the source terminal 100.

The CPU 104 of the source terminal 100 receives the IDR request from the sink terminal 200 and changes the highest bit rate value in the predetermined bit rate range to the highest bit rate value indicated by the received IDR request. With this process, a dynamic image can be transmitted from the source terminal 100 to the sink terminal 200 at a desired bit rate, which accordingly prevents the case where a dynamic image is not displayed on the sink terminal 200 in desired image quality when the source terminal 100 changes the highest bit rate value in response to the sink terminal 200 having stopped decoding a frame and repeatedly transmitted an IDR request to the source terminal 100.

The CPU 104 transmits the first response notifying of the changed highest bit rate value to the sink terminal 200 via the wireless communication module 103 (S1002). The CPU 104 changes the data format (such as the resolution and the frame rate) of a frame transmitted to the sink terminal 200 according to the predetermined bit rate range with its highest bit rate value changed (S1003). In specific, if the CPU 104 determines that, with the lowered highest bit rate, the current data format of the frame causes deterioration of the image quality of the dynamic image displayed on the sink terminal 200, the CPU 104 lowers at least one of the resolution and the frame rate of the frame transmitted to the sink terminal 200. On the other hand, if the CPU 104 determines that changing the current data format of the frame according to an increase of the highest bit rate value can improve the image quality of the dynamic image displayed on the sink terminal 200, the CPU 104 increases at least one of the resolution and the frame rate of the frame transmitted to the sink terminal 200.

The communication system according to the third embodiment can prevent the case where a dynamic image is not displayed on the sink terminal 200 in desired image quality when the source terminal 100 changes the bit rate in response to the sink terminal 200 having stopped decoding a frame and repeatedly transmitted an IDR request to the source terminal 100.

A communication system according to a fourth embodiment will now be described. In the present embodiment, the source terminal 100 receives an IDR request indicating the resolution of a frame transmitted to the sink terminal 200 and changes the resolution of the frame transmitted to the sink terminal 200 to the resolution indicated by the received IDR request. The same configuration as those of the above-described embodiments will not be described in the following description.

In the present embodiment, when the CPU 204 of the sink terminal 200 detects an error in decoding a frame of a dynamic image transmitted from the source terminal 100, the CPU 204 of the sink terminal 200 transmits an IDR request indicating the resolution of a frame of a dynamic image transmitted from the source terminal 100 to the source terminal 100 via the wireless communication module 203. In the present embodiment, the CPU 204 transmits an IDR request indicating the resolution input through the operation unit 206 to the source terminal 100.

The CPU 104 of the source terminal 100 receives the IDR request from the sink terminal 200 and changes the resolution of a frame transmitted to the sink terminal 200 to the resolution indicated by the received IDR request. With this process, a dynamic image with desired resolution can be transmitted from the source terminal 100 to the sink terminal 200, which accordingly prevents the case where the dynamic image is not displayed on the sink terminal 200 in desired image quality when the source terminal 100 changes the resolution in response to the sink terminal 200 having stopped decoding a frame and repeatedly transmitted an IDR request to the source terminal 100.

The communication system according the fourth embodiment can display a dynamic image on the sink terminal 200 in desired image quality.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented byway of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transmitting device comprising:
a display configured to display a dynamic image;
an encoder configured to encode the dynamic image displayed on the display and generate a dynamic image stream, the dynamic image stream including an IDR frame and a P frame subsequent to the IDR frame and having a bit rate within a first bit rate range; and
a controller configured to, when receiving first information instructing transmission of the IDR frame from an external device during a time of transmitting the P frame to the external device, lower an upper limit of the first bit rate range, cause the encoder to generate the IDR frame, transmit the generated IDR frame to the external device via wireless communication, and restart transmitting the P frame generated subsequent to the IDR frame.

2. The transmitting device according to claim 1, wherein the first information is transmitted to the transmitting device when an error in decoding the P frame is detected at the external device.

3. The transmitting device according to claim 1, wherein the controller receives the first information and changes the upper limit of the first bit rate range to a bit rate indicated by the first information, the first information indicative of the bit rate lower than the upper limit of the first bit rate range.

4. The transmitting device according to claim 1, wherein the controller receives the first information and changes the upper limit of the first bit rate range to a bit rate indicated by the first information, the first information indicative of a bit input to the external device.

5. The transmitting device according to claim 1, wherein the controller changes data formats of the P frame and the IDR frame in response to a change in the upper limit of the first bit rate range.

6. A receiving device comprising:
a display; and
a controller configured to receive a P frame of a dynamic image displayed on an external device from the external device at a bit rate within a first bit rate range, display a frame decoded from the received P frame using a frame prior to the P frame on the display, and, when an error in decoding the P frame is detected, transmit first information to the external device via wireless communication, the first information indicative of a bit rate lower than an upper limit of the first bit rate range and instructing transmission of an IDR frame.

7. The receiving device according to claim 6, wherein the controller receives an input of a bit rate serving as the upper limit of the first bit rate range and transmits the first information indicative of the input bit rate to the external device.
